(19) United States
(12) Patent Application Publication
(10) Pub. No.: US 2021/0156565 A1
(43) Pub. Date: May 27, 2021

(54) MODULAR RING FOR FIRE PIT ACCESSORIES

(71) Applicant: Ohio Flame, LLC, Columbiana, OH (US)

(72) Inventor: Matthew Skillman, Boardman, OH (US)

(73) Assignee: Ohio Flame, LLC, Columbiana, OH (US)

(21) Appl. No.: 16/691,075

(22) Filed: Nov. 21, 2019

(51) Int. Cl. F24B 3/00; A47J 37/07

(52) U.S. Cl. CPC F24B 3/00; A47J 37/0763; A47J 37/0786

(57) ABSTRACT

Provided is a modular fire pit system adaptable for use with a plurality of removable fire pit accessories. An exemplary embodiment of the modular fire pit system includes a modular ring for engaging a rim of a combustion bowl of a fire pit. The modular ring includes an annular portion for removably engaging the rim of the combustion bowl. The annular portion includes a central aperture, interior to a perimeter of the annular portion, for defining an opening to the combustion bowl. The annular portion also includes a lip portion protruding into the central aperture and defining a surface for interchangeably supporting one of the plurality of removable fire pit accessories. The removable fire pit accessories can include a snuffer lid, a grilling surface, a spark arrestor, or a wok.

### I. BACKGROUND

### A. Technical Field

This invention pertains to the field of structures for containing a recreational fire, especially for outdoor residential use. This invention pertains particularly to the field of fire pits, especially of the type used for multiple recreational uses that include various types of cooking.

### B. Description of Related Art

Fire pits are commonly used for enabling a user to safely contain a small fire in controlled setting, such as a residential backyard. Commercially available fire pit products are generally portable, including a combustion bowl and a base, thereby allowing set up in various locations such as a deck, backyard, or a driveway.

Fire pits can come in a variety of shapes and sizes. A common type fire pit has a combustion bowl having a generally circular profile, and with a generally circular rim. Fire pits can include a variety of accessories that engage with the rim of the combustion bowl. The accessories can include a snuffer lid, a grilling surface, and a spark arrestor. However, such a fire pit must have a specially designed rim that is shaped to engage and retain a mating surface on the accessories. Not all fire pits include such a specially designed rim, and therefore commercially-available accessory products cannot be used with them.

Moreover, many fire pit products are adapted to only include one type of accompanying accessory, such as a spark arrestor. Such product designs cannot be adapted to use any accessories that are not specifically sold for use with that particular product. Such fire pit designs thus lack flexibility and usefulness.

Further, different types of fire pits come with different rim diameters. Such accessories have a mating surface specifically designed to engage the specific rim having the specific diameter of the specific type of fire pit for which they were designed. Such accessories are not in any way adaptable for use with other fire pit designs.

### II. SUMMARY

Provided in this disclosure is a modular fire pit system adaptable for use with a plurality of removable fire pit accessories. An exemplary embodiment of the modular fire pit system includes a modular ring for engaging a rim of a combustion bowl of a fire pit. The modular ring includes an annular portion for removably engaging the rim of the combustion bowl. The annular portion includes a central aperture, interior to the perimeter of the annular portion, for defining an opening to the combustion bowl. The annular portion also includes a lip portion protruding into the central aperture and defining a surface for interchangeably supporting each one of the plurality of removable fire pit accessories.

The removable fire pit accessories can include a snuffer lid, a grilling surface, a spark arrestor, or a wok. Each of the plurality of removable fire pit accessories includes a peripheral portion proportioned to be received within the central aperture of the modular ring and to thereby engage the lip portion. The lip portion includes an engagement surface for engaging and supporting the peripheral portion of each of the plurality of removable fire pit accessories.

In an exemplary embodiment of the invention, the annular portion includes an associated top surface. The engagement surface of the lip portion is set below a plane of the top surface, in such a way that the annular portion top surface is flush with a peripheral portion top surface. The annular portion also includes a ledge surface, generally perpendicular to the annular portion top surface and the engagement surface, for abutting a mating surface of the peripheral portion of each of the plurality of removable fire pit accessories.

The annular portion can have a variety of different configurations with respect to the rim of the combustion bowl. The annular portion can be received within the interior portion of the rim or it can sit atop the rim. In an embodiment where the annular portion sits atop the rim, the annular portion can include a collar portion for engaging a portion of the rim or the complete circumference. The collar portion can engage the interior portion or the exterior portion of the rim of the combustion bowl. In an alternate exemplary embodiment of the invention, the annular portion of the modular ring can include a circumferential extension, which can define a work surface for the fire pit.

According to one aspect of the invention, the modular ring provides a removable component that can adapt a fire pit to receive a plurality of different accessories.

According to another aspect of the invention the modular ring provides a standardized component that enables different types of accessories to be used with a fire pit.

According to yet another aspect of the invention, the modular ring can designed to accommodate fire pits having different rim diameters or configurations, and otherwise provide a greater range of flexibility and usefulness.

Other benefits and advantages of this invention will become apparent to those skilled in the art to which it pertains upon reading and understanding of the following detailed specification.

### III. BRIEF DESCRIPTION OF THE DRAWINGS

The disclosed muffler may take physical form in certain parts and arrangement of parts, embodiments of which will be described in detail in this specification and illustrated in the accompanying drawings which form a part hereof and wherein:

FIG. 1 is an exploded perspective view of a fire pit system including a modular ring with accessory in accordance with an exemplary embodiment of the present invention;

FIG. 2 is a top view of a modular ring in accordance with an exemplary embodiment of the present invention;

FIG. 3 is a top view of a modular ring with a snuff lid in accordance with an exemplary embodiment of the present invention;

FIG. 4 is a top view of a modular ring with a cooking grate lid in accordance with an alternate exemplary embodiment of the present invention;

FIG. 5 is an exploded perspective view of a fire pit including a modular ring with a spark arrestor accessory in accordance with a further alternate exemplary embodiment of the present invention;

FIG. 6 is an exploded perspective view of a fire pit including a modular ring with a wok accessory in accordance with an additional exemplary embodiment of the present invention;

FIG. 7 is a side-sectional view showing a configuration of a modular ring and accessory with a rim portion of a combustion bowl in accordance with an exemplary embodiment of the present invention;

FIG. 8 is a side-sectional view showing a configuration of a modular ring and accessory with a rim portion of a combustion bowl in accordance with an alternate exemplary embodiment of the present invention;

FIG. 9 is a side-sectional view showing a configuration of a modular ring and accessory with a rim portion of a combustion bowl in accordance with a further alternate exemplary embodiment of the present invention;

FIG. 10 is a side-sectional view showing a configuration of a modular ring and accessory with a rim portion of a combustion bowl in accordance with an additional alternate exemplary embodiment of the present invention; and

FIG. 11 is a side-sectional view showing a configuration of a modular ring and accessory with a rim portion of a combustion bowl in accordance with a further additional alternate exemplary embodiment of the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

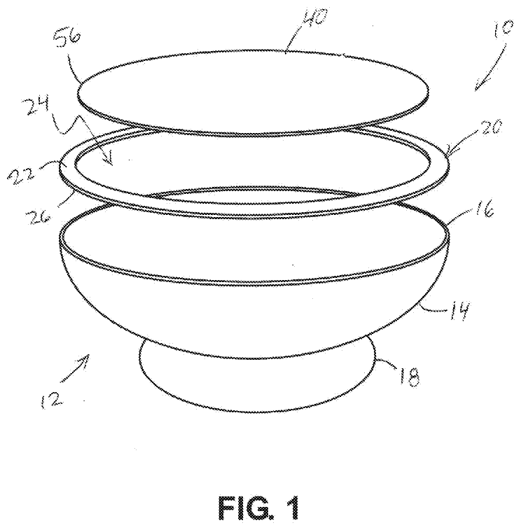

FIG. 1 is an exploded perspective view of a fire pit system 10 in accordance with an exemplary embodiment of the present invention. A fire pit 12 includes a combustion bowl 14 for retaining a combustible material, such as wood or the like. However, it is to be appreciated that the present fire pit 12 could be adapted for use with propane or other combustible gas. The combustion bowl 14 has a rim 16 which defines the extent of the combustion bowl 14 such that the combustible material is generally contained within the extent of the rim 16. The combustion bowl 14 and other components of the fire pit 10 are preferably formed of stainless steel, in order to resist oxidation from containing fires. However, any suitable oxidation-resistant material could also be used without departing from the invention.

As depicted in the exemplary embodiment of FIG. 1, the combustion bowl 14 is generally hemispherical, having a generally circular profile. In this respect, the rim 16 is generally circumferential around the extent of the combustion bowl 14. However, it is to be appreciated that the combustion bowl 14 can be of any suitable shape, having any suitable profile, including square, rectangular, ellipsoidal, polytopic, and of any other figure, all without departing from the invention. In such alternative embodiments, the rim 16 would generally define a perimeter of the combustion bowl 14.

The exemplary embodiment of FIG. 1 includes a base 18 for supporting the combustion bowl 14. As shown, the base 18 is generally hemispherical. However, it is to be appreciated that the base 18 can be of any suitable shape, including having a plurality of legs or other supports, or a flattened portion on the bottom side of the combustion bowl 14 or any other suitable configuration for providing a stable support surface for the combustion bowl 14.

As also shown in the exemplary embodiment of FIG. 1, a modular ring 20 is provided for engagement with the fire pit 12. The modular ring 20 includes an annular portion 22 for removably engaging the rim 16 of the combustion bowl, as will be described in greater detail hereinbelow. The annular portion 22 includes a central aperture 24, interior to a perimeter 26 of the annular portion 22, for defining an opening to the combustion bowl 14. The central aperture 24 of the modular ring 20 is generally sized and proportioned to interchangeably receive a fire pit accessory 40, one of a plurality of removable fire pit accessories, as will also be described in greater detail hereinbelow. In the preferred embodiment, the central aperture 24 is circular in order to receive a fire pit accessory 40 having a corresponding circular shape.

In the preferred embodiment, the annular portion 22 is generally circular and configured to engage a circumferential rim 16 of a generally hemispherical combustion bowl 14. However, in an alternative embodiment where the combustion bowl 14 is non-circular, the annular portion 22 can have a corresponding non-circular shape to engage the rim 16 defining the perimeter of such a non-circular combustion bowl 14, all without departing from the invention. Similarly, a central aperture 24 can also have a suitable non-circular shape, in order to receive a fire pit accessory 40 having a corresponding non-circular shape, also without departing from the invention.

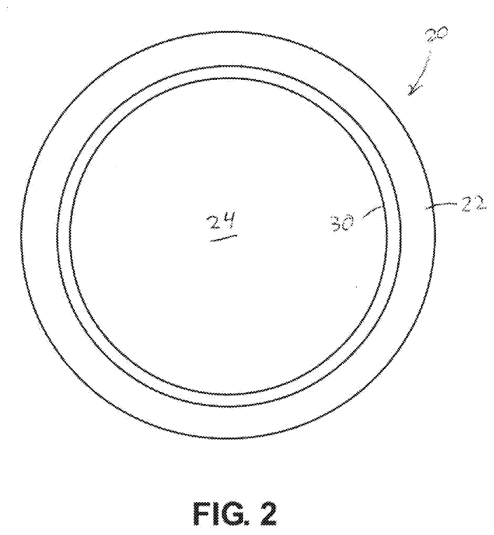

FIG. 2 is a top view of the modular ring 20 in accordance with an exemplary embodiment of the present invention. As depicted, the modular ring 20 includes the annular portion 22 and the central aperture 24 as described hereinabove. The modular ring 20 also includes a lip portion 30 that protrudes into the central aperture 24. The lip portion 30 defines a surface for interchangeably supporting an interchangeable fire pit accessory 40 selected from the plurality of removable fire pit accessories, as will be explained in greater detail hereinbelow.

The annular portion 22, the lip portion 30, and any other tangible components of the modular ring are preferably formed of stainless steel, in order to resist oxidation from containing fires. However, any suitable oxidation-resistant material could also be used without departing from the invention.

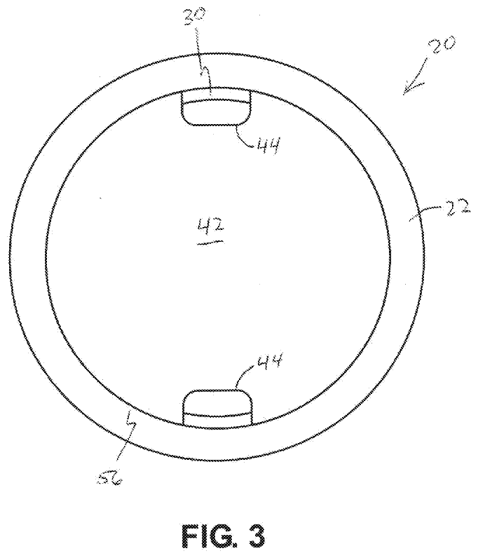

FIG. 3 is a top view showing the modular ring 20 according to an exemplary embodiment of the invention an including a fire pit accessory in the form of a snuff lid 42 which is retained within the central aperture 24, interior with respect to the annular portion 22. As indicated in the figure, the snuff lid 42 is thus a generally circular piece, intended to function as a cover for the fire pit 10, and especially to snuff or extinguish the fire. However, since the shape of the snuff lid 42 is configured to reside within the central aperture 24, the snuff lid 42 can have any suitable non-circular shape to correspond to a non-circular central aperture 24, without departing from the invention.

The snuff lid 42 includes gaps 44 which enable handling and removal of the snuff lid 42, with a poker, tongs or other suitable fire handling implements. The gaps 44 provide a grasping surface which can be used to pry or grasp the snuff lid 42 away from the modular ring 20 for repositioning or removal, as desired.

As shown in FIG. 3, the snuff lid 42 rests upon the lip portion 30. The lip portion 30 thereby defines a surface for supporting the snuff lid 42 and any other interchangeable fire pit accessory 40 selected from the plurality of removable fire pit accessories. The snuff lid 42 is preferably formed of stainless steel, in order to resist oxidation from containing fires. However, any suitable oxidation-resistant material could also be used without departing from the invention.

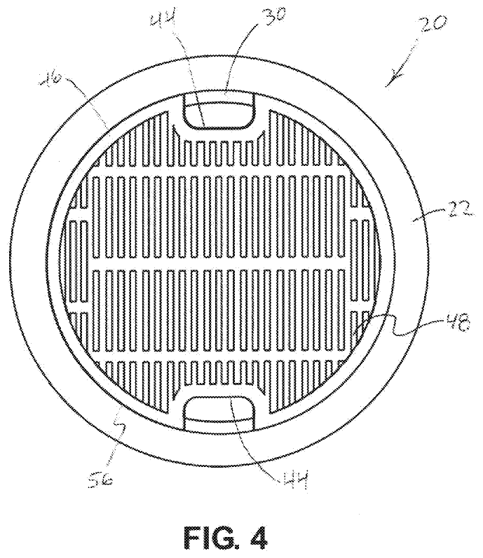

FIG. 4 is a top view showing the modular ring 20 according to an alternate exemplary embodiment of the invention including a fire pit accessory in the form of a cooking grate 46 which is retained within the central aperture 24, interior with respect to the annular portion 22. As indicated in the figure, the cooking grate 46 is thus a generally circular piece, intended to function as a cooking surface over the fire pit 10, including an array of openings 48 to allow heat to rise up to the food and allow any liquids from the food to drip into the fire. However, since the shape of the cooking grate 46 is configured to reside within the central aperture 24, the cooking grate 46 can have any suitable non-circular shape to correspond to a non-circular central aperture 24, without departing from the invention.

The cooking grate 46 also includes gaps 44 which enable handling and removal of the cooking grate 46 with a poker, tongs or other suitable fire handling implements. The gaps 44 provide a grasping surface which can be used to pry or grasp the cooking grate 46 away from the modular ring 20 for repositioning or removal, as desired.

As shown in FIG. 4, the cooking grate 46 rests upon the lip portion 30. The lip portion 30 thereby defines a surface for supporting the cooking grate 46 and any other interchangeable fire pit accessory 40 selected from the plurality of removable fire pit accessories. The cooking grate 46 is preferably formed of stainless steel in order to resist oxidation from containing tires. However, any suitable oxidation-resistant material could also be used without departing from the invention.

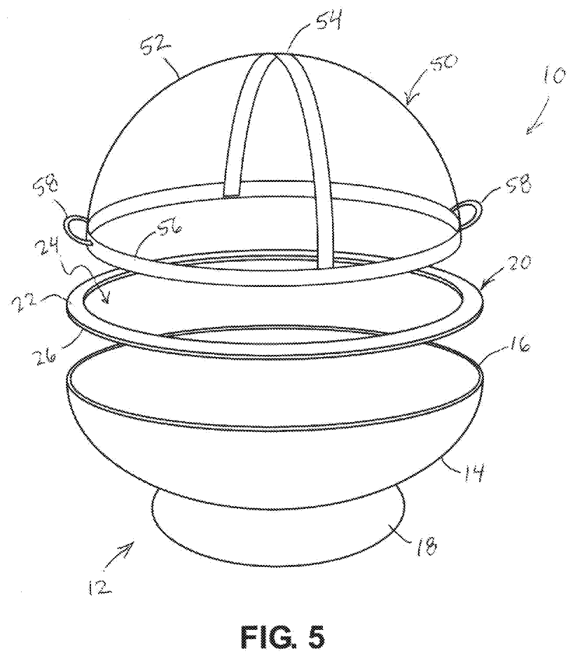

In the exploded perspective view of FIG. 5, a fire pit 10 is shown including a modular ring 20 with a spark arrestor accessory 50 in accordance with a further alternate exemplary embodiment of the present invention. The exploded view of FIG. 5 is similar to the view of FIG. 1 where like reference numerals refer to like components. As indicated in FIG. 5, the central aperture 24 is interior to the perimeter 26 of the annular portion 22, and is generally sized and proportioned to receive the spark arrestor 50. As indicated, the central aperture 24 is circular in order to receive the spark arrestor 50 which has a corresponding circular shape.

The spark arrestor 50 is designed to prevent sparks from escaping from the combustion bowl 14. Accordingly, the spark arrestor 50 includes a dome 52 formed of a mesh of oxidation-resistant material such as stainless steel. The dome 52 is encircled by a support 54 which provides structural strength to the mesh material. Though only one support 54 is indicated, a spark arrestor 50 can include two or more supports 54. The spark arrestor 50 also includes a peripheral portion 56 in the form of a support that provides structural strength to the mesh material of the dome 52. The peripheral portion 56 rests atop the lip portion 30, enclosed within the annular portion 22, and thereby provides support to the spark arrestor 50.

The other embodiments including various types of accessories 40 as disclosed and illustrated herein also include a type of peripheral portion 56 that defines the extent of the accessory 40 and fits within the central aperture 24 and engages the lip portion 30 of the modular ring 20, as indicated by like reference numerals in other figures.

In the embodiment of FIG. 5, first and second handles 58 are connected to the peripheral portion 56, in order to facilitate placement and removal of the spark arrestor 50. It is to be appreciated that the spark arrestor 50 of FIG. 5 can be of a non-circular shape and can fit inside a corresponding non-circular central aperture 24 in a circular annual portion 22, and rest upon a corresponding non-circular lip portion 30. Similarly, a circular or non-circular spark arrestor 50 can be retained in a corresponding non-circular modular ring 20 adapted to engage a non-circular rim 16 of a non-circular combustion bowl 14, as described hereinabove, all without departing from the invention.

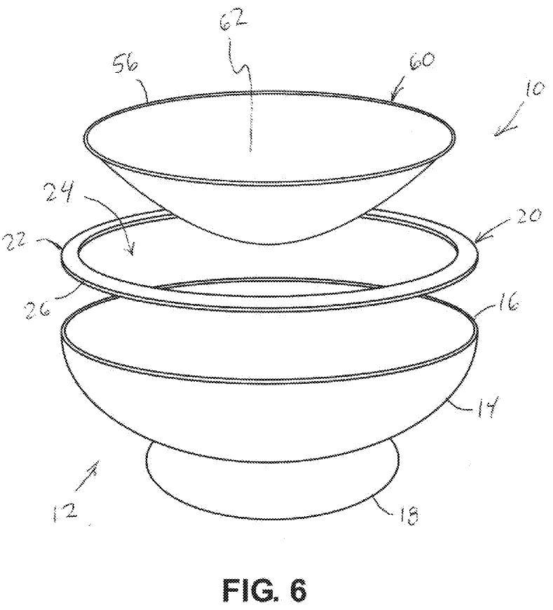

In the exploded perspective view of FIG. 6, a fire pit 10 is shown including a modular ring 20 with a wok accessory 60 in accordance with a further alternate exemplary embodiment of the present invention. The exploded view of FIG. 6 is similar to the views of FIGS. 1 and 5 where like reference numerals refer to like components. As indicated in FIG. 6, the central aperture 24 is interior to the perimeter 26 of the annular portion 22, and is generally sized and proportioned to receive the wok 60. As indicated, the central aperture 24 is circular in order to receive the wok 60 which has a corresponding circular shape.

The wok accessory 60 is a cooking vessel particularly intended for preparing Chinese food and other meals that include sauces and other liquids. The wok 60 includes a concave basin 62 and a peripheral portion 56 in the form of a rim defining the outer edge of the wok 60. The wok 60 is supported on the lip portion 30 of the annular portion 22 along the peripheral portion 56, so that the concave basin 62 extends down into the combustion bowl 14.

As with the embodiment of FIG. 5, the wok 60 can also include handles connected to the peripheral portion 56 to facilitate placement and removal. The wok 60 can also include one or more spacers (not shown) in the vicinity of the peripheral portion 56 to allow heat and combustion gases to escape the combustion bowl 14, and also to regulate and control the amount of heating on the wok 60.

Though a wok 60 traditionally has a circular shape, it is to be appreciated that the wok accessory 60 depicted in FIG. 6 can be fashioned as a cooking vessel having a non-circular profile to fit inside a corresponding non-circular central aperture 24 in a circular annual portion 22, and rest upon a corresponding non-circular lip portion 30. Similarly, a circular or non-circular wok 60 or other similar cooking vessel can be retained in a corresponding non-circular modular ring 20 adapted to engage a non-circular rim 16 of a non-circular combustion bowl 14, as described hereinabove, all without departing from the invention.

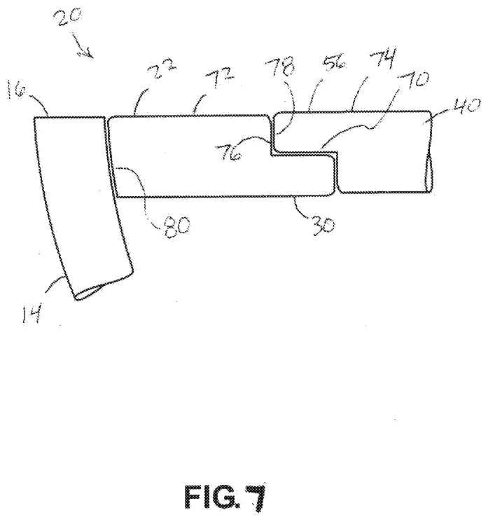

FIGS. 7-11 are side-sectional views depicting exemplary embodiments of various engagements of the modular ring 20 with the combustion bowl 14 and the selected accessory 40, in accordance with the invention. The views of FIGS. 7-11 particularly depict how each of the plurality of removable fire pit accessories 40 include the peripheral portion 56 proportioned to be received within the central aperture 24 in order to engage the lip portion 30. In these views, the peripheral portion 56 is shown as a type of projection that extends forth from the respective fire pit accessory 40. This type of peripheral portion 56 is most useful in the snuffer lid 42 and cooking grate 46 embodiments shown respectively in FIGS. 3 and 4 hereinabove. However, different types of peripheral portions 56 could be also contemplated, such as a peripheral portion 56 having an edge that sits entirely atop the lip portion 30 without a projection. Such a peripheral portion 56 could be best adapted for use with the spark resistor 50 and wok 60 embodiments, all without departing from the invention.

As also shown in FIGS. 7-11, the lip portion 30 includes an engagement surface 70 for engaging and supporting the peripheral portion 56 of each of the plurality of removable fire pit accessories 40. The engagement surface 70 faces generally upward in order to engage a downward-facing surface on the peripheral portion 56, and thereby provide support for the respective accessory 40.

As further shown in FIGS. 7-11, the annular portion 22 includes an annular portion top surface 72 that defines an upwardly facing surface. The engagement surface 70 of the lip portion 30 is set below the plane of the top surface 72. In this manner, the annular portion top surface 72 is flush with a top surface 74 of the peripheral portion 56. In this manner, the top surface 74 of the peripheral portion 56 is generally coplanar with the top surface 72 of the annular portion 22. In the snuffer lid 42 and cooking grate 46 embodiments shown respectively in FIGS. 3 and 4, the top surfaces of these respective accessories 40 are thus generally coplanar with the modular ring 20, presenting a smooth, finished appearance.

As additionally shown in FIGS. 7-11, the annular portion 22 also includes a ledge surface 76, generally perpendicular to the top surface 72 of the annular portion 22 and also the engagement surface 70, in order to provide a type of notch for retaining the respective accessory 40. In this manner, the ledge surface 76 provides a surface for abutting a mating surface 74 of the peripheral portion 56 of the respective fire pit accessory 40.

As particularly depicted in the embodiment of FIG. 7, the annular portion 22 of the modular ring 20 is received within an interior portion of the rim 16 of the combustion bowl 14. As shown, an end portion 80 of the annular portion 22 can be beveled or shaped to conform with a curved surface near the rim 16 of the combustion bowl 14. In this manner, the modular ring 20 can have a mating surface for engaging the rim 16 and thereby be suitably retained and supported.

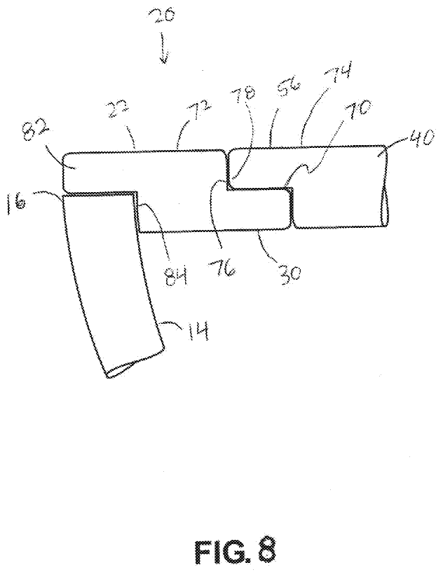

As particularly depicted in the embodiment of FIG. 8, the annular portion 22 of the modular ring 20 includes a collar portion 82 that sits atop the rim 16 of the combustion bowl 14. A collar portion 82 is formed continuously with the annular portion 22 and thus defines a notch 84 that engages an interior portion of the rim 16. In this manner, the interior portion of the rim 16 cooperates with the notch 84 to retain the modular ring 20 into engagement with the combustion bowl 14. The collar portion 82 can be a continuous extension of the annular portion 22, encircling the entire circumference thereof. Alternatively, the collar portion 82 can be discontinuous and only engaging the rim 16 in selected portions of the circumference of the annular portion 22, all without departing from the invention.

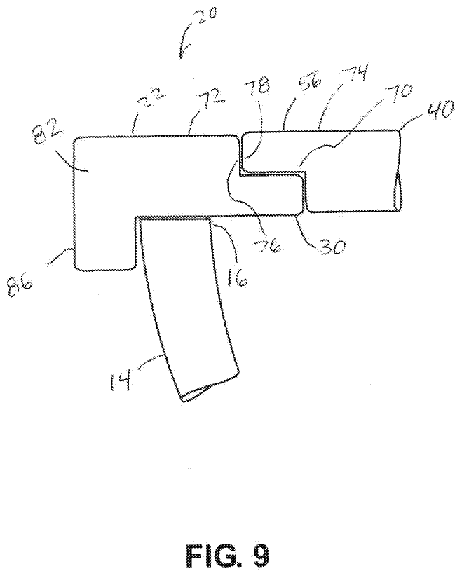

As particularly depicted in the embodiment of FIG. 9, the collar portion 82 includes a band 86 that engages an exterior portion of the rim 16 of the combustion bowl 14. In this manner, the exterior portion of the rim 16 cooperates with the band 86 to retain the modular ring 20 into engagement with the combustion bowl 14. The band 86, like the collar portion 82, can encircle the entire circumference of the annular portion 22. Alternatively, the band 86 can be discontinuous and only engage the rim 16 in selected portions of the circumference of the annular portion 22, all without departing from the invention.

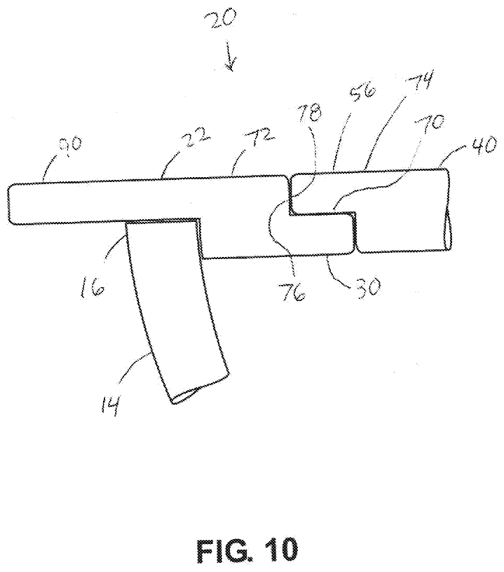

As particularly depicted in the embodiment of FIG. 10, the annular portion 22 of the modular ring 20 further includes a circumferential extension 90 that extends beyond the rim 16 of the combustion bowl 14. As depicted in the figure, the circumferential extension 90 can be formed continuously with the collar portion 82 that sits atop the rim 16 of the combustion bowl 14, and extends outwardly in a radial direction away from the center of the combustion bowl 14. Alternatively, the circumferential extension 90 can be a discrete component than can be added onto the modular ring 20. The circumferential extension 90 can provide a work surface for the fire pit 10, upon which tools or other items can be rested for cooking or tending the fire pit.

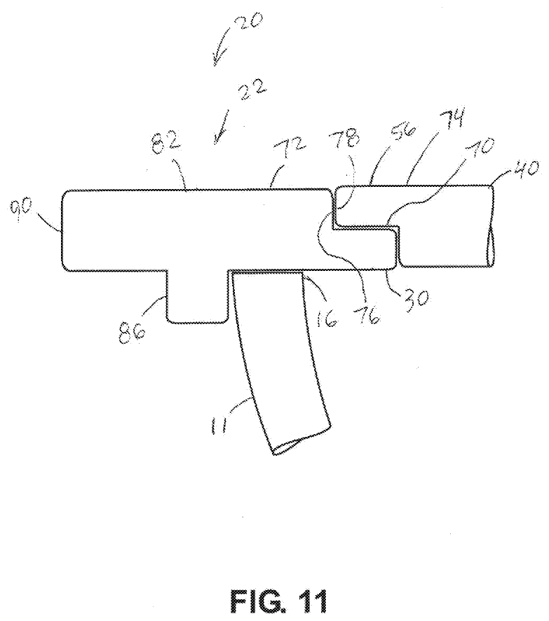

In the embodiment of FIG. 10, the circumferential extension 90 is formed in accordance with the embodiment of FIG. 8 in which the collar portion 82 defines a notch 84 that engages an interior portion of the rim 16. In the alternate embodiment of FIG. 11, the circumferential extension 90 is formed in accordance with the embodiment of FIG. 9 in which the collar portion 82 includes a band 86 that engages an exterior portion of the rim 16 of the combustion bowl 14. In both of the embodiments of FIGS. 10 and 11 the circumferential extension 90 is continuous with the modular ring 20 and extends outwardly in a radial direction away from the center of the combustion bowl 14, or alternatively, a discrete component than can be added onto the modular ring 20, in order to provide a work surface for the fire pit 10, upon which tools or other items can be rested for cooking or tending the fire pit.

As described herein, the modular ring 20 and related components can be adapted for use with a standard, commercially-available fire pit product, to provide flexibility and adaptability to users of existing fire pits. Alternatively, the modular ring 20 and related components as described herein can be incorporated into a complete modular fire pit system, to provide a fire pit with additional functionality and usefulness compared to such fire pit systems as are known in the art.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A modular ring for supporting one of a plurality of fire pit accessories, the modular ring comprising:
an annular portion for removably engaging a rim of a combustion bowl of a fire pit, the annular portion includes a central aperture, interior to a perimeter of the annular portion, for defining an opening to the combustion bowl; and
a lip portion protruding into the central aperture and defining a surface for interchangeably supporting one of the plurality of removable fire pit accessories.

2. The modular ring of claim 1, wherein each of the plurality of removable fire pit accessories comprises a peripheral portion proportioned to he received within the central aperture and engage the lip portion.

3. The modular ring of claim 2, wherein the lip portion includes an engagement surface for engaging and supporting the peripheral portion of each of the plurality of removable fire pit accessories.

4. The modular ring of claim 3, wherein the annular portion includes an annular portion top surface and wherein the engagement surface of the lip portion is set below a plane of the top surface, such that the annular portion top surface is flush with a peripheral portion top surface.

5. The modular ring of claim 4, wherein the annular portion further comprises a ledge surface, generally perpendicular to the annular portion top surface and the engagement surface, for abutting a mating surface of the peripheral portion of each of the plurality of removable fire pit accessories.

6. The modular ring of claim 1, wherein the annular portion is received within an interior portion of the rim of the combustion bowl.

7. The modular ring of claim 1, wherein the annular portion sits atop the rim of the combustion bowl and further comprising a collar portion for engaging at least a portion of the rim.

8. The modular ring of claim 7, wherein the collar portion includes a notch that engages an interior portion of the rim of the combustion bowl.

9. The modular ring of claim 7, wherein the collar portion includes a band that engages an exterior portion of the rim of the combustion howl.

10. The modular ring of claim 1, wherein the annular portion further comprises a circumferential extension, defining a work surface for the fire pit.

11. he modular ring of claim 1, wherein the plurality of removable fire pit accessories comprises: a snuffer lid, a grilling surface, a spark arrestor, or a wok.

12. A fire pit, comprising:
a combustion bowl for retaining a combustible material, and comprising a rim for defining a perimeter of the combustion bowl;
a base for supporting the combustion bowl; and
a modular ring comprising:
an annular portion for removably engaging the rim of the combustion bowl, the annular portion includes a central aperture, interior to a perimeter of the annular portion, for defining an opening to the combustion bowl;
a lip portion protruding into the central aperture and defining a surface for interchangeably supporting one of a plurality of removable fire pit accessories.

13 A modular fire pit system, comprising:
a plurality of removable fire pit accessories; and
a modular ring for engaging a rim of a combustion bowl of a fire pit, the modular ring comprising:
an annular portion for removably engaging the rim of the combustion bowl, the annular portion includes a central aperture, interior to a perimeter of the annular portion, for defining an opening to the combustion bowl;
a lip portion protruding into the central aperture and defining a surface for interchangeably supporting one of the plurality of removable fire pit accessories.
